(19) United States
(12) Patent Application Publication
(10) Pub. No.: US 2010/0022375 A1
(43) Pub. Date: Jan. 28, 2010

(54) Method for the Production of Packaging Bags Having a Reinforced Base Region and Device for Carrying Out the Method

(75) Inventor: Tiziano Colla, Dino (CH)

Correspondence Address: THE WEBB LAW FIRM, P.C., 700 KOPPERS BUILDING, 436 SEVENTH AVENUE, PITTSBURGH, PA, 15219, US

(73) Assignee: WATER-LINE SA, Mezzovico (CH)

(21) Appl. No.: 12/375,080

(22) PCT Filed: Jul. 20, 2007
(86) PCT No.: PCT/CH2007/000357

§ 371 Date: Jun. 5, 2009

(30) Foreign Application Priority Data
Jul. 27, 2006 (CH) 1225/06

(51) Int. Cl. B31B 1/00

(52) U.S. Cl. 493/243; 493/267

(57) ABSTRACT

In a method for the production of packaging bags made of plastic film a section of the packaging bag disposed on one end of the packaging bag is folded upwards along a laterally extending folding line as the folding section, and glued to the packaging bag. Before it is folded, an adhesive is applied to at least one of the two surfaces to be glued. A hot glue is used as the adhesive. The adhesive is applied approximately simultaneously in the form of a plurality of adhesive sections.

### TECHNICAL FIELD

The present invention is concerned with the field of producing packaging bags. It relates to a method for producing packaging bags, in particular having a reinforced base region, and to a device for carrying out the method.

### PRIOR ART

For packaging animal feed or the like, use is nowadays made of high-grade, stable packaging bags made of plastic film material. The film material used here is either a single-layer material or a multi-layer material in which, for example, films made of different plastics can be combined with an aluminum foil in between. The bags are produced by first forming a film tube which is usually provided with lateral folds. Transversely extending weld seams are incorporated at regular intervals in the film tube and form the base closure of the subsequent packaging bags.

There is a risk when filling the bags with contents and when subsequently transporting and using the filled bags that the weld seams will not withstand the loading and will become undone. This is especially a problem when the packaging bags are intended for relatively large packages having contents weighing 1.5 kg, 2 kg or more.

There has consequently been an increasing switch to providing the packaging bags with a base reinforcement which is produced by folding over a base portion and bonding the folded-over base portion to the bag. However, the folded-over base portion can also be provided with an imprint for advertising or information purposes, which can be read when the bag is in the horizontal position. Such a packaging bag having a base reinforcement is depicted in simplified form in FIGS. 6 and 7. The packaging bag 30 has a front side 34 and a rear side 35, and also lateral folds 36 and 37. In the base region 32, a folding portion 21 is folded over rearwardly along a folding line 22 and bonded to the rear side 35 of the packaging bag 30. FIG. 6 shows a fill opening 31 at the top, through which the bag can be filled or emptied. Various measures can be adopted to close of the fill opening 31. In particular, the opening can be designed to be reclosable, for example by means of a zipper.

In order to bond the folding portion 21, use is conventionally made of an adhesive application 33 in the form of a hot glue or hot-melt adhesive which is applied to the rear side 35 of the packaging bag 30 parallel to the folding line 22, i.e. transversely over the bag, and across the entire width of the packaging bag 30. The spiral adhesive application 33 is produced using a fine adhesive nozzle which is guided transversely across the entire width of the bag with a circular movement. Once the adhesive application 33 has been completely deposited, the folding portion 21 is folded over and pressed onto the adhesive application 33.

However, the described manner of base reinforcement or adhesive application has disadvantages which can be found particularly in the lack of durability of the adhesive bonding or in the lack of mechanical strength: the hot glue used, when applied directly from the (heated) adhesive nozzle to the outer plastic film on the rear side 35 of the packaging bag 30, leads to intimate bonding with the film, resulting in few problems arising as far as this bonding is concerned. However, the situation is different for the bonding between the adhesive application 33 and the inner side of the folded-over folding portion 21. Applying the adhesive to the packaging bag demands a comparatively long period of time since the adhesive application goes across the entire width of the bag. Consequently, the already applied adhesive cools before the adhesive application has finished. Furthermore, an outer skin forms on the surface of the adhesive, the skin having a reduced adhesive power. Given the long time period involved when applying the adhesive, it is not uncommon, especially with large bags, for the pot life (use period) of the adhesive to be exceeded. Tests have shown that the folding portion 21 can be detached from the packaging bag by hand without applying a large degree of force. It has also been observed in this respect that the adhesive bonded only to that side to which it was applied. The resulting adhesion between the adhesive application 33 and the film of the folding portion 21 is then more akin to a contact adhesion and occurs without intimate bonding between the adhesive and film.

The folding portion 21 can then become detached when subjected to increased loading—for example during filling or if its slightly jutting outer edge catches behind a projection—and thus cancel out the intended effect of the base reinforcement.

FR 969,987 discloses a paper bag which is substantially designed as a folding bag having bonded seems. The base region of the paper bag can have a folded-over design, wherein the folded-over section can be bonded with the surface of the paper bag. A disadvantage is that the paper bag is weakened in the region of the adhesive application by this application. In particular, the paper bag can tear in the region of the adhesive application.

### SUMMARY OF THE INVENTION

It is therefore an object of the invention to specify a method for producing a packaging bag, in particular having a (bonded) base reinforcement, which avoids the disadvantages of known methods and leads in a simple manner to a base reinforcement having a high loading capacity. It is further intended to specify a device for carrying out the method. In particular, it is intended to specify a method or a device which accelerates the operation of producing a base reinforcement. In particular, it is intended to reduce the time between the start of the adhesive application and the operation of folding over the folding portion.

The object is achieved by the features of the independent claims.

Accordingly, a method for producing packaging bags made of plastic film is specified, in which method a portion of the packaging bag, constituting a folding portion, arranged at one end of the packaging bag is folded over upward along a transversely extending folding line and bonded with the packaging bag. Prior to the folding-over operation, an adhesive is applied to at least one of the two surfaces to be bonded. The adhesive used is a hot glue. According to the invention, the adhesive is applied approximately simultaneously in the form of a plurality of adhesive sections.

The essence of the invention is to configure the adhesive application, in particular using a plurality of distributed adhesive nozzles, in such a way that the time for the adhesive application can be reduced. Thus, the bonding operation can take place very quickly after the application of the adhesive, and the applied adhesive can bond intimately with both surfaces to be bonded. There results an adhesive bond having a high mechanical strength since, owing to the short period of time between application and bonding, the adhesive bonds by both surfaces on both surfaces to be bonded.

The adhesive sections are preferably arranged at a distance from one another. This is advantageous as the adhesive can therefore be applied in a short time. Alternatively, the adhesive sections can be arranged adjacent to one another or overlapping one another.

A loadable and permanent bonding is achieved in that the application of the adhesive and the subsequent operation of folding over the folding portion take place in such a way that the adhesive bonds substantially over the entire length of the adhesive application, that is to say the adhesive section, with the two surfaces to be bonded.

In particular, the adhesive is applied in the form of a plurality of individual, short sections distributed over the width of the packaging bag, wherein preferably each of the adhesive sections or sections of the adhesive application is assigned its own adhesive nozzle.

According to one development, the sections or adhesive sections have the form of adhesive beads, wherein, in order to apply the adhesive beads, the packaging bag and/or the adhesive nozzles are moved.

In particular, the adhesive beads can preferably extend approximately or exactly transversely with respect to the longitudinal direction of the bag. However, they can also extend obliquely with respect to the longitudinal direction of the bag.

However, it is also conceivable for the adhesive beads to extend in the longitudinal direction of the bag.

The adhesive beads here can also cross over the folding line.

According to another development, the sections have the form of adhesive spots.

Another embodiment of the method according to the invention is characterized in that the adhesive is applied to both surfaces to be bonded in such a way that adhesive applications on both surfaces are caused to lie against one another, in particular congruently, during the folding-over operation. This results in a particularly good adhesive bond.

It is particularly advantageous if the folding portion is folded over and pressed onto the packaging bag directly after the adhesive application has ended, wherein the adhesive application and the subsequent operations of folding over and pressing on the folding portion preferably take place over a time period of a few tenths of a second.

Another embodiment of the method according to the invention is distinguished in that the individual packaging bags are cut off a continuous tubular film web which is in each case transversely welded upstream of the subsequent separating points, in that the free end of the film web is in each case first conveyed into the position intended for the adhesive application and retained there, in that the packaging bag is then separated from the film web, and in that, directly after the separating operation, the adhesive is applied and the folding portion is folded over.

A development is characterized in that, in the position intended for the adhesive application, the free end of the film web bears by its underside on a retaining device and is retained there by means of negative pressure, in that, in the position intended for the adhesive application, the free end of the film web protrudes by the folding portion freely beyond the retaining device, and in that the freely protruding folding portion is folded over across its entire width along the folding line by means of a pivotable folding device.

In one embodiment according to the invention of the device for carrying out the method, a gluing device and a folding device, in particular a base-processing unit, are arranged behind one another in the conveying direction along a conveying plane. The folding device is intended for folding over a folding portion of the packaging bag to be produced, and, directly in front of the folding device, the adhesive device is provided with a plurality of distributed adhesive nozzles. The adhesive nozzles are designed for the approximately simultaneous application of a hot glue to obtain a plurality of adhesive sections.

One embodiment of the device according to the invention is characterized in that a retaining device operating with negative pressure is provided inside the base-processing unit in the region of the adhesive nozzles, said retaining device applying suction to and securing the film web lying thereon during the processing operation, and in that hold-down elements are arranged above the retaining device and hold down the film web at its edges against the retaining device.

Another embodiment of the device according to the invention is characterized in that the distance between the cutting unit and the processing unit in the conveying direction is adjustable, and in that a length-adjustable, first belt-type conveying device is arranged between the two units.

Another embodiment of the device according to the invention is characterized in that a second belt-type conveying device having two belts running in parallel is provided behind the processing unit, between which belts the ready-processed packaging bags are conveyed while being compressed.

A further embodiment of the device according to the invention is characterized in that the folding device comprises a pivotable beam arranged transversely with respect to the conveying direction.

In the device according to the invention, the adhesive nozzles can be mounted in a fixed position above the conveying plane; however, they can also be mounted above the conveying plane such that they can be moved in the transverse direction.

### BRIEF DESCRIPTION OF THE FIGURES

The invention will be explained in more detail below with reference to exemplary embodiments in conjunction with the drawing, in which:

FIG. 1 in a number of sub-figures, FIG. 1A to 1F, shows, in side view and in highly simplified form, various steps during the production of packaging bags having a base reinforcement according to a preferred exemplary embodiment of the invention;

FIG. 2 shows, in plan view from above, an adhesive application in the form of a plurality of transversely extending adhesive beads according to one exemplary embodiment of the invention;

FIG. 3 shows the configuration from FIG. 2 after folding over the folding portion;

FIG. 4 shows, in plan view from above, an adhesive application in the form of a plurality of adhesive beads extending obliquely or in the longitudinal direction according to another exemplary embodiment of the invention;

FIG. 5 shows, in plan view from above, an adhesive application in the form of a plurality of adhesive spots according to a further exemplary embodiment of the invention;

FIG. 6 shows, in perspective side view, a packaging bag having a base reinforcement as is known from the prior art;

FIG. 7 shows a continuously spiral adhesive application known from the prior art for the base reinforcement;

FIG. 8 shows a preferred exemplary embodiment of a device according to the invention in side view;

FIG. 9 shows the device from FIG. 8 in a perspective representation;

FIG. 10 shows, in a representation comparable to FIG. 8, the device as seen from the other side, wherein the distance between the cutting unit and the processing unit is set to a maximum;

FIG. 11 shows, in a somewhat simplified representation comparable to FIG. 9, the device with a maximum distance between the cutting unit and the processing unit;

FIG. 12 shows, in a perspective view, a further embodiment of a base-processing unit according to the invention; and

FIG. 13 shows a side view of the base-processing unit 11.

### WAYS OF IMPLEMENTING THE INVENTION

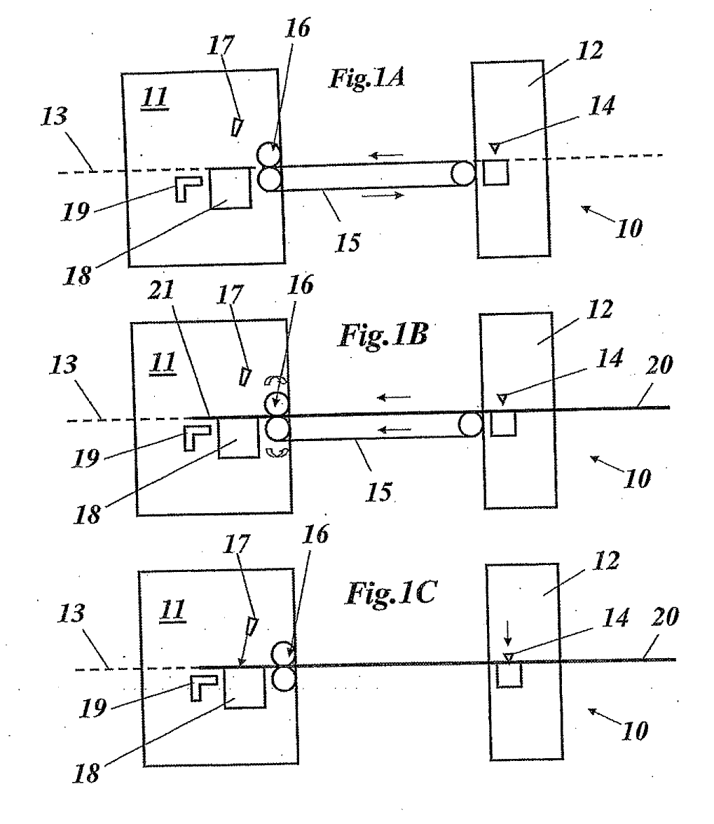

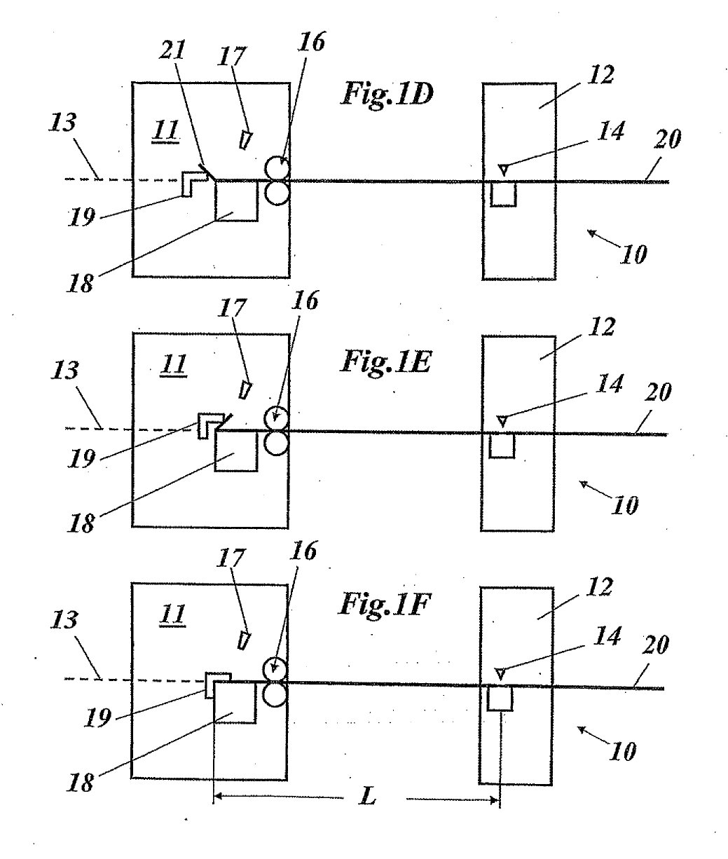

FIG. 1, in a number of sub-figures, FIG. 1A to 1F, shows, in side view and in highly simplified form, various steps during the production of packaging bags having a base reinforcement according to a preferred exemplary embodiment of the invention. The device 10 for producing a packaging bag according to FIG. 1A comprises a cutting unit 12 and a base-processing unit 11 which are arranged behind one another along a horizontal conveying plane 13. Between both units 11 and 12 is provided a conveying device 15 in the form of a belt which runs over rollers. For reasons of clarity, the conveying device 15 has been omitted from sub-FIGS. 1C to 1F. The left roller of the conveying device 15 is part of a roller pair 16 by means of which the film web (20 in FIG. 1B) can be drawn precisely into the base-processing unit 11 and retained there in the intended processing position. The distance between the two units 11 and 12 corresponds to the length of the packaging bag (L in FIG. 1F) and can preferably be adjusted. The conveying device 15 can then be correspondingly adapted in length.

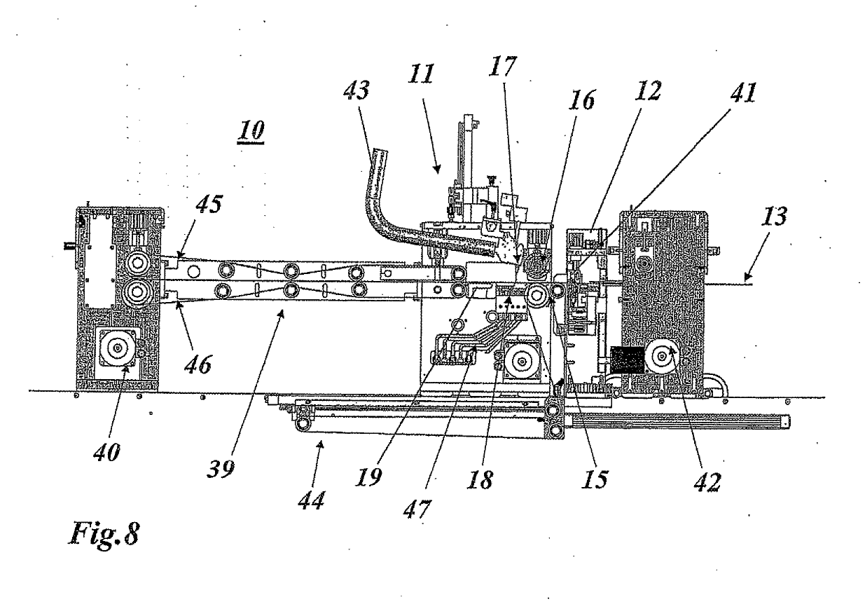

In the cutting unit 12 is provided a cutter 14 by means of which in each case one packaging bag is separated from the continuous film web 20. The cutter 14 is schematically indicated in FIG. 1 as a cutter beam which cuts from top to bottom. In a preferred embodiment of the device, the cutter is designed as a cutter which is arranged below the conveying plane 13, can move in the transverse direction and cuts through the film web 20 in the transverse direction and in the process engages in the groove of a clamping beam (41 in FIG. 8) which presses from above onto the film web 20 and fixes said web.

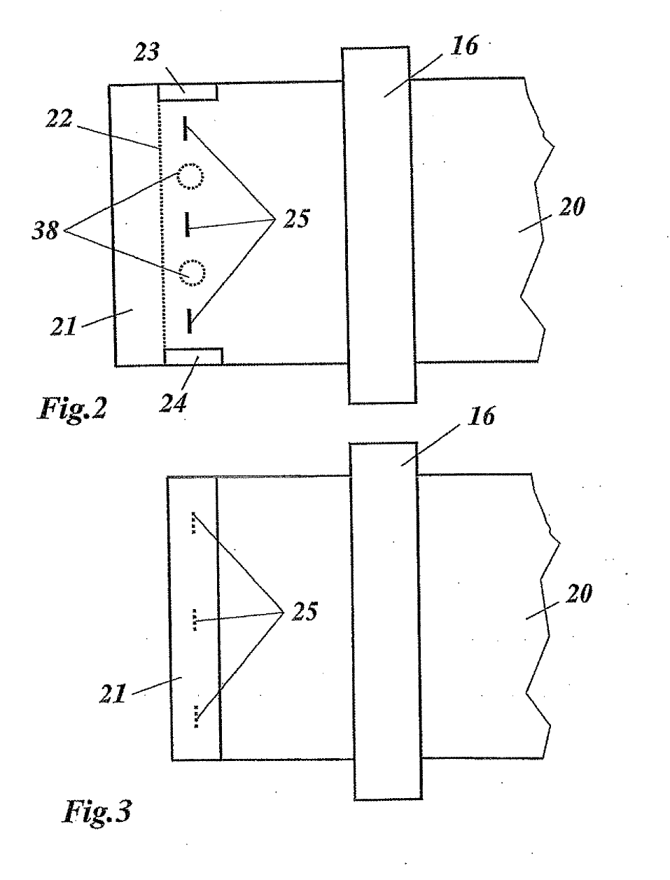

In the processing unit 11, the conveying plane 13 extends over a retaining device 18 arranged behind the roller pair 16, said device being supplied with negative pressure and being provided on its upper side with suction openings (38 in FIG. 2) which, through negative pressure, can apply suction to and fix the overlying film web 20. Above the retaining device 18 is provided a row made up of a plurality of spaced-apart adhesive nozzles 17 extending in the transverse direction, through which nozzles a suitable hot glue, which is fed in via heated or thermally insulated feeds (not shown), can be sprayed in a targeted manner onto the upper side of the film web 20.

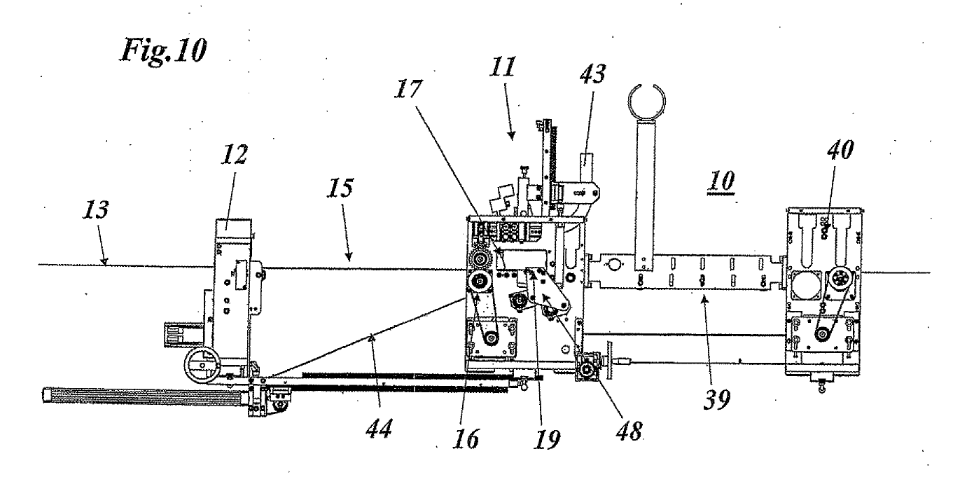

In the conveying direction (from right to left) behind the retaining device 18 is positioned a folding device 19 which comprises a transversely oriented beam which, by virtue of an articulated mechanism (48 in FIG. 10) and while maintaining its orientation, can be pivoted upward, toward the retaining device 18 and down onto the retaining device 18 (see FIGS. 1D to 1F). The folding device 19 folds a folding portion 21, which protrudes freely beyond the holding device, back onto the film web 20 in order there, by bonding with one side of the film web 20, to form the base reinforcement of the next packaging bag.

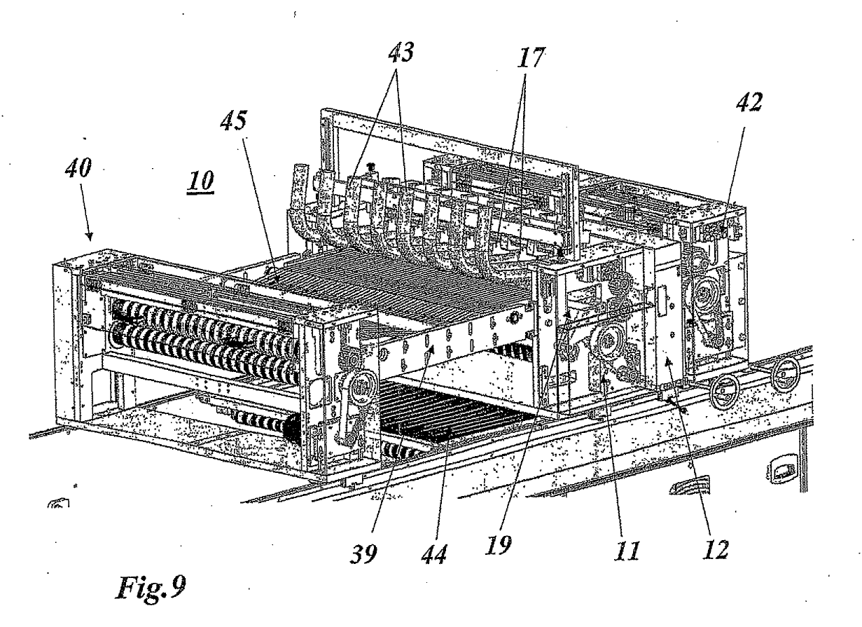

At the start of the processing cycle (which lasts in total about 1 s for example), a conveying device (not shown here) to the right in front of the cutting unit 12 (42 in FIGS. 8, 9), the conveying device 15 and the roller pair 16 are used to draw the (continuous) film web 20 forward through the cutting unit 12 and so far into the processing unit 11 that it has a web portion of predetermined length, which corresponds to the folding portion 21, protruding beyond the retaining device 18 (FIG. 1B). The roller pair 16 here is operated at a speed which is higher by about 1% than that of the conveying device 42, with the result that the film web is always drawn tight. Since the film web 20 at this time is still uncut, the portion of the film web 20 that is intended for the next packaging bag can be introduced into the processing unit 11 with high positioning accuracy and without slipping. In the region of the retaining device 18 is arranged a sensor which detects the presence of the film web and sends a corresponding signal to the controller of the processing unit 11.

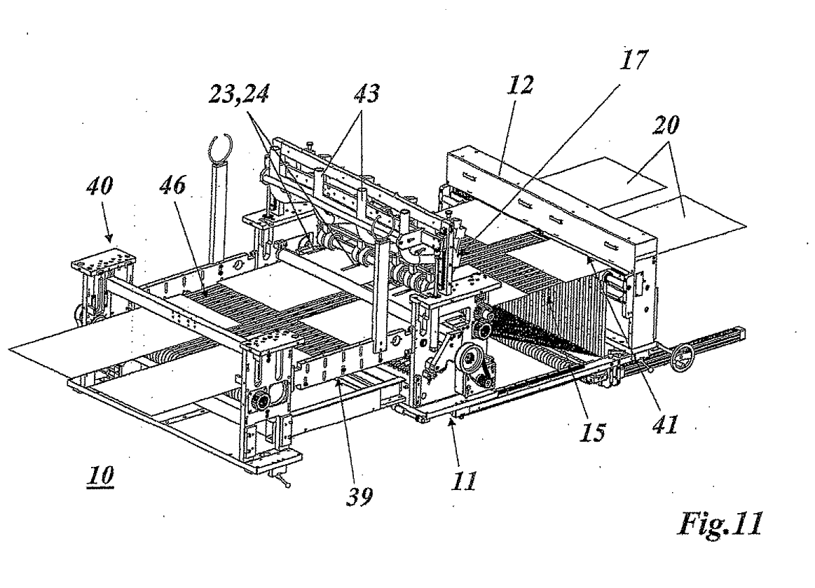

As soon as the film web 20 has reached its end position as shown in FIG. 1B, the film web is severed in the cutting unit 12. The separated portion is now fixed by the roller pair 16, and also by the retaining unit 18 which by means of installed valves switches the negative pressure to the suction openings 38. In addition, there are also provided a plurality of hold-down elements (23, 24 in FIGS. 2, 11) at the lateral edges and/or in the center of the film web 20, these elements being designed as resilient sheet metal strips and holding down the film web 20 at the edges or else in the center up to the folding line (22 in FIG. 2). At virtually the same time as the film web 20 is being severed, adhesive is applied for a short time via the adhesive nozzles 17 to the upper side of the cut-off packaging bag (FIG. 1C), this being indicated by an arrow on the adhesive nozzle 17. Depending on the type of adhesive application, the nozzle arrangement can be moved in different directions, resulting in correspondingly formed and oriented adhesive beads (see FIGS. 2-4). An adhesive bead is substantially intended to mean an adhesive application along a predetermined contour. The contour can be understood, for example, to be a straight line, a continuous line or else a point. However, a combined movement of the nozzles 17 and the film web 20 can also be provided in order to obtain a defined adhesive application. In this case, the film web is not fixed by negative pressure during the adhesive application. The arrangement of a plurality of adhesive nozzles 17 makes it possible for a plurality of adhesive beads or adhesive sections to be applied approximately simultaneously. Such individual adhesive sections do not extend across the entire width of the bag, but over a plurality of smaller sections or adhesive sections. Applying the adhesive with a plurality of adhesive nozzles 17 allows a reduction in the time between the start of the adhesive application and the folding-over operation after the application of the hot glue, that is to say the actual bonding. This ensures that the temperature of the adhesive drops only insignificantly before it can undergo bonding with the folding portion 21.

The approximately simultaneous application can take place at the same time or staggered in time for all the adhesive sections. By staggered in time is meant that, with all the adhesive sections, the adhesive application is to be started within a defined time period. In particular, the time period here should not exceed the time period which is necessary for the application of an adhesive section.

The adhesive sections are preferably arranged adjacent to one another or at a distance from one another or overlapping one another. This is dependent on the length of the adhesive section. If the adhesive sections are adjacent to one another, the two neighboring adhesive sections are in contact with one another. In the arrangement where the sections are at a distance from one another, an interspace without adhesive is present between the adhesive sections. In the overlapping arrangement, the neighboring adhesive sections overlap one another.

Immediately (a few tenths of a second) after the application of the hot glue (FIG. 1C), the folding portion 21 which protrudes beyond the retaining unit 18 is folded over upward along the folding line 22 and pressed from above onto the film web by means of the pivotable folding device 19. The folding line 22 here may already have been predefined by an indentation line or bead line which was incorporated in the film web 20 during the preliminary stage of applying the transversely extending weld seams, said folding line facilitating the folding-over operation. It is conceivable, for example, to produce the indentation line or bead line using a reheated beam. The preheated beam can slightly deform the bags 30 in the desired portion. For folding-over purposes, the beam-shaped folding device 19 engages at the beginning of the pivoting operation below the folding portion 21 and moves it upward (FIG. 1D), then folds the folding portion 21 rearwardly counter to the conveying direction (FIG. 1E) and then presses the folding portion 21 onto the film web 20 (FIG. 1F), wherein the applied hot glue bonds intimately both with the folding portion 21 and film web 20. Since the adhesive is applied from a plurality of nozzles simultaneously and only over short distances and is directly followed by the folding operation, the entire operation can be completed in a very short time. The hot glue applied in the melted state thus maintains its full adhesive and bonding power during the base-processing operation, with the result that the bonding of the folding portion is very stable and long-lasting.

In the context of the distributed and multiple simultaneous adhesive application, a wide variety of configurations are conceivable within the scope of the invention. Some of the particularly preferred types of adhesive application are depicted in FIGS. 2 to 5: in the exemplary embodiment of FIG. 2, with the film web stationary, three adhesive nozzles 17 arranged next to one another and moved transversely with respect to the conveying direction, or adhesive jets, produce three straight adhesive beads 25 which then result in the folding portion 21 being bonded at three sites to the film web 20 or to the already cut-off packaging bag portion (FIG. 3). After the adhesive beads 25 have been applied, the adhesive nozzles 17 can return to their starting position for the next adhesive application. More simpler still is to move the adhesive nozzles one way during one adhesive application and to move them back again during the following next adhesive application.

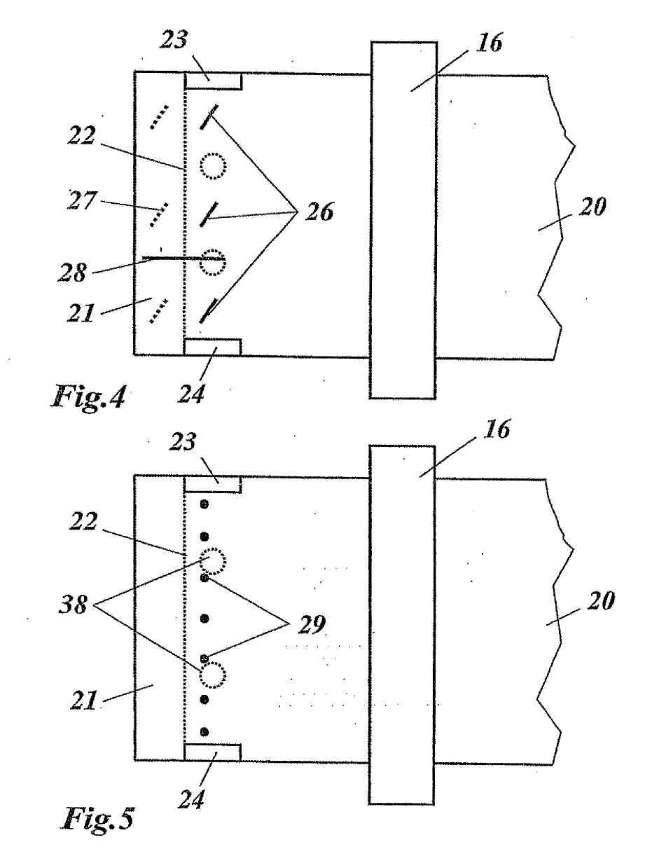

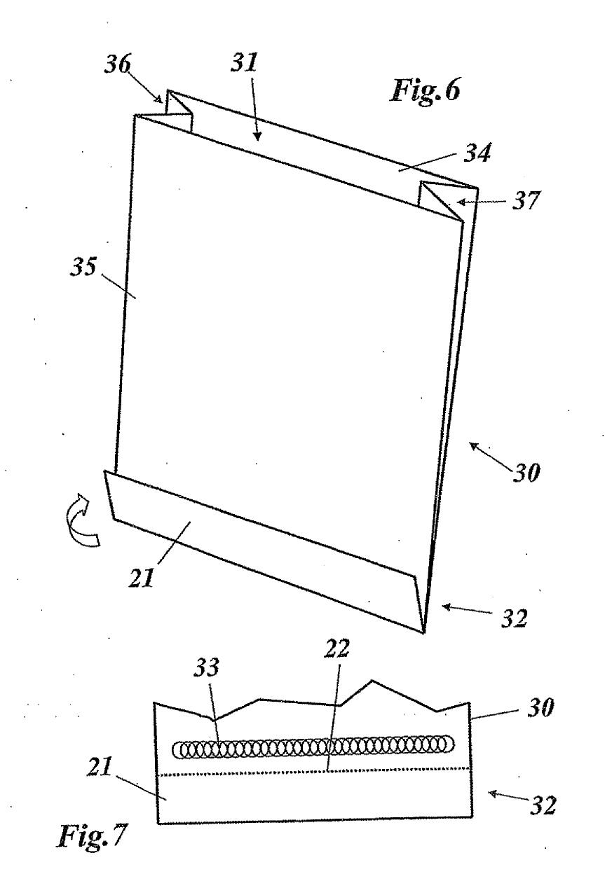

In order, apart from a bonding extending in the transverse direction, also to obtain a bonding extending in the conveying direction, it is also possible, as shown in FIG. 4, for obliquely extending adhesive beads 26 to be applied. The oblique profile here can be produced either through a corresponding movement of the adhesive nozzles 17 or adhesive jets or through a corresponding superimposition of two orthogonal movements of the adhesive nozzles 17 (adhesive jets) and of the film web 20 itself.

FIG. 4 also shows that the adhesive can be applied optionally in front of and/or behind the folding line 22. If analogous adhesive beads 27 are also applied on the other side of the folding line 22, crossed adhesive paths result after the folding-over operation. However, the adhesive beads on both sides of the folding line 22 can also be oriented in such a way that they lie. exactly above one another after the folding-over operation. In this way, the adhesive beads are optimally anchored in the film material, and the adhesive of the adhesive beads lying above one another bonds directly during the folding-over operation.

However, as shown in FIG. 4, it is also conceivable to produce adhesive beads 28 which extend in the longitudinal direction and which may also reach over and beyond the folding line 22 just by correspondingly advancing the film web 20 with stationary adhesive nozzles 17, or adhesive jets, or by moving the adhesive nozzles 17 in the conveying direction with a stationary film web 20. These adhesive beads 28, of which only one is illustrated in FIG. 4 by way of example, can be interrupted at the folding line 22. If they run as far as the outer edge of the folding portion 21 and start correspondingly soon on the other side of the folding line 22, the base reinforcement can thus be bonded over the entire reinforcing region.

It is further conceivable, as shown in FIG. 5, for adhesive spots 29 to be applied instead of or in addition to elongate adhesive beads of the type shown in FIG. 2 and 4. As shown in FIG. 5, these adhesive spots 29 can be arranged in a straight line; however, they can also be distributed across the width of the film web 20 in another configuration (for example along a zigzag line). The adhesive spots 29 can be applied even more quickly than the adhesive beads. It is also possible for the adhesive nozzles 17 to be able to move in the vertical direction (see FIG. 11).

A preferred exemplary embodiment of a device according to the invention is depicted in detail in side view in FIG. 8 (and FIG. 10). The main parts of the device have already been represented schematically in FIG. 1. The device 10 is built on a subframe (not represented in more detail) which, inter alia, allows the cutting unit 12 to be able to be displaced relative to the processing unit 11 for adaptation to different bag lengths (in FIG. 8, the minimum distance between the cutting unit 12 and processing unit 11 is set; the superfluous belt length of the conveying device 15 arranged between the cutting unit 12 and processing unit 11 is taken up by a movable arrangement of deflection rollers which are present below the device; in FIG. 10, the maximum distance is set). The uncut, continuous film web is conveyed, coming from the right, through the cutting unit 12 into the processing unit 11 by means of a first drive unit 42 which is arranged directly in front of the cutting unit 12 and which is equipped with a motor-driven roller pair, at which processing unit the end of the film web is received by the roller pair 16 and conveyed up to and slightly beyond the retaining unit 18. A plurality of negative pressure lines 47, coming from below, extend to the retaining unit 18 and, via valves arranged in the retaining unit 18, lead to the suction openings 38 (two are illustrated by way of example in FIG. 2) whose function has already been described further above.

Above the retaining unit 18 is arranged the transversely oriented row of the adhesive nozzles 17 (as shown in FIG. 9, in the exemplary embodiment a total of 8 adhesive nozzles 17 at a uniform distance from one another are available for two film webs to be processed next to one another, that is to say four nozzles each for one film web; as shown in FIG. 11, two nozzles each for two webs are available) which are supplied with the hot glue through thermally insulated adhesive feeds 43. The adhesive nozzles 17 themselves are heated and are controlled via a valve arranged directly behind the nozzle. In the example shown in FIGS. 8 and 9, the adhesive nozzles 17 are mounted fixed in position. However, it is of course possible to design them such that they are able to move transversely.

The roller pair 16 not only guides the film web to the retaining device 18 but also conveys the cut-off bag, which is ready-finished on its base side, further to a subsequent conveying device 39, where the bag is further conveyed for subsequent handling (monitoring, packaging etc.) in a compressed state between two belts 45, 46 running in parallel. Compressing the bags between the belts mechanically assists the bonding operation in the base region until the hot glue has sufficiently cooled. The two belts 45, 46 here are driven by a second drive unit 40. Not only the two belts 45, 46 but also the belt 44 are subdivided into a plurality of separate part-belts, as can be seen in FIGS. 9 and 11.

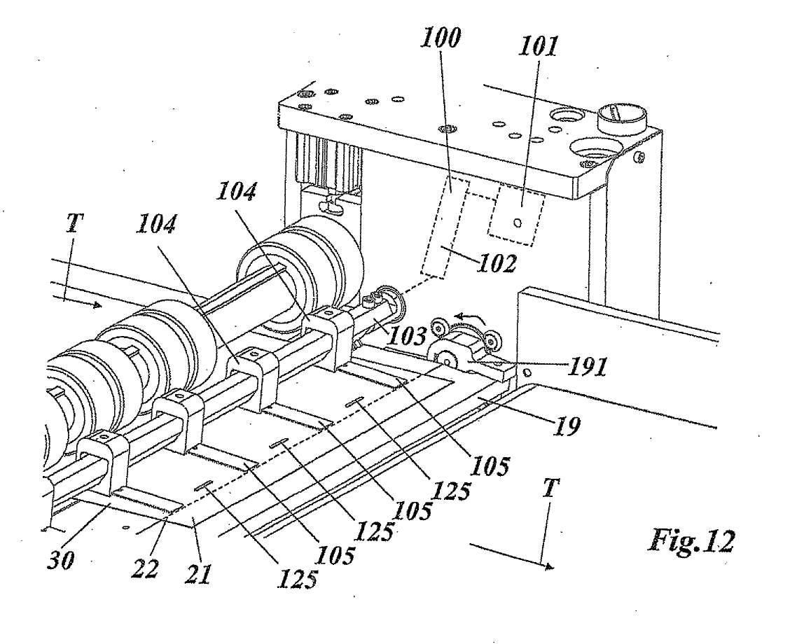

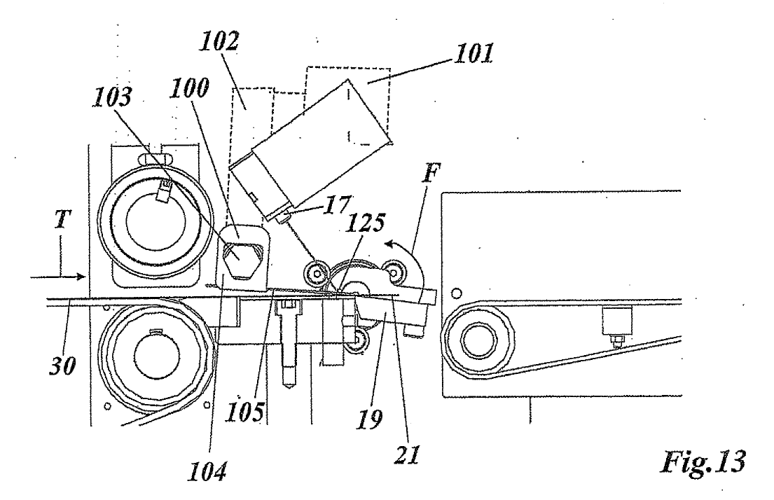

FIGS. 12 and 13 show a further embodiment according to the present invention. Identical parts are provided with identical reference signs. Furthermore, features from the preceding exemplary embodiments can be combined with one another and with this further exemplary embodiment as desired to form new exemplary embodiments. The arrow T represents the conveying direction.

As is shown in FIG. 12, the device further comprises a hold-down device 100. The hold-down device 100 comprises a drive 101, a coupling element 102, a transmission rod 103, a plurality of fastening components 104 and hold-down elements 105 fastened to said components. The drive 101, which is represented here as a pneumatic cylinder, applies a movement to the transmission rod 103 via the coupling element 102. In this regard, the coupling element 102, by virtue of its bearing arrangement, is moved with a pivoting movement. The transmission rod 103 is moved with an equivalent movement. The fastening components 104 are mounted fixed in position or movably on the transmission rod 103. Each of the fastening components 104 comprises a hold-down element 105 which projects in the direction of the bonding site 125. The hold-down element 105 is preferably designed as a flexible plate, in particular made of spring steel. The hold-down elements 105 can also be designated as being of finger-shaped design.

Between each two neighboring adhesive nozzles 17 is preferably placed one hold-down device 100. The hold-down element 105 here projects into a region between two adhesive sections or bonding sites 125 such that the hold-down elements 105 do not come into contact with the adhesive.

The drive of the hold-down device is actuated with the insertion of the bag into the base-processing unit 11. Here, the hold-down elements 105 project into the region of the folding portion 21 of the bag and press the bag against the conveying plane 13. After applying the adhesive and carrying out the folding operation, the drive of the hold-down device is actuated again and the hold-down elements move back out of the interspace between the bag and folding portion 21 with a pivoting movement counter to the conveying direction of the device.

FIGS. 12 and 13 also indicate a further embodiment of the folding device 19. The folding device 19 shown there comprises a folding beam 190 which, left and right of the conveying direction, is connected to a folding lever 191. The folding lever 191 is driven via a servo motor (not shown). As soon as the adhesive has been applied, the folding lever 191 performs a rotary movement and thus moves the folding beam 190 in the direction of the folding portion 21 of the bag. As the movement continues, the folding portion 21 is seized and folded in the direction of the adhesive sites and pressed against them there. It is possible by displacing the folding beam 190 relative to the center of rotation for the folding beam to be adjusted to suit the thickness of the bag material to be folded. The folding beam is moved along the arrow F.

Other alternative types of folding or folding devices are also conceivable.

### LIST OF REFERENCE SIGNS

10 Device for producing a packaging bag

11 Base-processing unit

12 Cutting unit

13 Conveying plane

14 Cutter

15,39 Conveying device (belt-type)

16 Roller pair

17 Adhesive nozzle

18 Retaining device (negative pressure)

19 Folding device

20 Film web (tubular)

21 Folding portion

22 Folding line

23,24 Hold-down element

25,26,27,28 Adhesive bead

29 Adhesive spot

30 Packaging bag

31 Fill opening

32 Base region

33 Adhesive application

34 Front side

35 Rear side

36,37 Lateral fold

38 Suction opening

40,42 Drive unit

41 Clamping beam

43 Adhesive feed (thermally insulated)

44, . . . , 46 Conveyor belt

47 Negative pressure line

48 Articulated mechanism (folding device)

100 Hold-down device

101 Drive for hold-down elements

102 Coupling element

103 Transmission rod

104 Fastening components

105 Hold-down element

190 Folding beam

191 Folding lever

125 Adhesive section

L Length (bag)

T Conveying direction

F Folding direction

1-31. (canceled)

32. A method for producing packaging bags said packaging bag comprising:
a folding portion arranged at one end of the packaging bag, said folding portion is folded over upward along a transversely extending folding line towards the packaging bag,
adhesive material arranged on a surface of said packaging bag and/or on a surface of said folding portion, wherein said adhesive material is arranged between said folding portion and said packaging bag to bond said folding portion to the packaging bag;
said packaging bag is made of plastic film;
wherein said method comprises the steps of:
applying said adhesive to at least one of the two surfaces to be bonded, wherein said adhesive is applied approximately simultaneously in the form of a plurality of adhesive sections; and
folding-over said folding portion.

33. The method as claimed in claim 32, wherein the adhesive sections are arranged adjacent to one another or at a distance from one another or overlapping one another.

34. The method as claimed in claim 32, wherein the packaging bag has a reinforced base region, and in that said portion is a portion arranged at the lower end.

35. The method as claimed in claim 32, wherein the method further comprises the step of closing the packaging bag at the end to be folded over.

36. The method as claimed in claim 32, wherein the adhesive is applied in the form of a plurality of individual, short adhesive sections distributed over the width of the packaging bag.

37. The method as claimed in claim 32, wherein each of the adhesive sections of the adhesive application is assigned its own adhesive nozzle.

38. The method as claimed in claim 32, wherein the adhesive sections have the form of adhesive beads and wherein, in order to apply the adhesive beads, the packaging bag and/or the adhesive nozzles are moved.

39. The method as claimed in claim 32, wherein the adhesive beads extend transversely with respect to the longitudinal direction of the bag and/or
wherein the adhesive beads extend obliquely with respect to the longitudinal direction of the bag and/or
wherein the adhesive beads extend in the longitudinal direction of the bag.

40. The method as claimed in claim 32, wherein the adhesive beads cross over the folding line and/or
wherein the sections have the form of adhesive spots or of adhesive lines and/or
wherein the adhesive is applied to both surfaces to be bonded in such a way that adhesive applications on both surfaces are caused to lie against one another during the folding-over operation.

41. The method as claimed in claim 32, wherein the folding portion is folded over and pressed onto the packaging bag directly after the adhesive application has ended and/or
wherein the adhesive application and the subsequent operations of folding over and pressing on the folding portion take place over a time period of a few tenths of a second.

42. The method as claimed in claim 32, wherein during the application of the adhesive and/or during the folding-over operation, the bag is held by means of hold-down elements which extend between the adhesive sections.

43. The method as claimed in claim 32, wherein the individual packaging bags are cut off a continuous tubular film web which is in each case transversely welded upstream of the subsequent separating points, in that the free end of the film web is in each case first conveyed into the position intended for the adhesive application and retained there, wherein the packaging bag is then separated from the film web, and wherein, directly after the separating operation, the adhesive is applied and the folding portion is folded over.

44. The method as claimed in claim 32, wherein in the position intended for the adhesive application, the free end of the film web bears by its underside on a retaining device and is retained there by means of negative pressure, wherein, in the position intended for the adhesive application, the free end of the film web protrudes by the folding portion freely beyond the retaining device, and wherein the freely protruding folding portion is folded over across its entire width along the folding line by means of a pivotable folding device.

45. A device for carrying out a method for producing packaging bags
wherein said packaging bag comprises:
a folding portion arranged at one end of the packaging bag, said folding portion is folded over upward along a transversely extending folding line towards the packaging bag,
adhesive material arranged on a surface of said packaging bag and/or on a surface of said folding portion, wherein said adhesive material is arranged between said folding portion and said packaging bag to bond said folding portion to the packaging bag;
said packaging bag is made of plastic film;
wherein said method comprises the steps of:
applying said adhesive to at least one of the two surfaces to be bonded, wherein said adhesive is applied approximately simultaneously in the form of a plurality of adhesive sections; and
folding-over said folding portion;
wherein said device comprises:
a gluing device adapted to apply the adhesive comprising a plurality of distributed adhesive nozzles which are adapted for the simultaneous application of a hot glue to obtain a plurality of adhesive sections;
a folding device adapted for folding over a folding portion of the packaging bag to be produced;
wherein said gluing device and said folding device are arranged behind one another in the conveying direction along a conveying plane, wherein said gluing device is arranged directly in front of the folding device.

46. The device as claimed in claim 45, wherein the gluing device and the folding device are part of a base-processing unit adapted to provide the base of the packaging bag.

47. The device as claimed in claim 45, wherein a hold-down device is arranged with a plurality of hold-down elements, wherein each hold-down element is arranged between two adjacent adhesive nozzles such that the hold-down element extends between the adhesive sections.

48. The device as claimed in claim 45, wherein a cutting unit and the base-processing unit are arranged behind one another in the conveying direction along a conveying plane, wherein the film web can be guided through the cutting unit, and in that means for feeding a continuous tubular film web to the adhesive device and folding device are provided in the conveying plane.

49. The device as claimed in claim 45, wherein the adhesive nozzles are arranged transversely with respect to the longitudinal direction of the bag or conveying direction.

50. The device as claimed in claim 45, wherein a retaining device which operates with negative pressure is provided inside the base-processing unit in the region of the adhesive nozzles, said device applying suction to and securing the film web lying thereon during the processing operation.

51. The device as claimed in claim 45, wherein the hold-down elements are arranged above the retaining device and hold down the film web at its edges against the retaining device.

52. The device as claimed in claim 45, wherein the distance between the cutting unit and the processing unit in the conveying direction can be adjusted, and in that a length-adjustable, first belt-type conveying device is arranged between the two units.

53. The device as claimed in claim 45, wherein a second belt-type conveying device having two belts extending in parallel is provided behind the processing unit, between which belts the ready-processed packaging bags are conveyed while being compressed.

54. The device as claimed in claim 45, wherein the folding device comprises a pivotable beam arranged transversely with respect to the conveying direction.

55. The device as claimed in claim 45, wherein the adhesive nozzles are mounted fixed in position above the conveying plane and/or wherein the adhesive nozzles are mounted above the conveying plane such that they can be moved in the transverse direction.
